(19) United States
(12) Patent Application Publication
(10) Pub. No.: US 2026/0236937 A1
(43) Pub. Date: Aug. 13, 2026

(54) INFORMATION MANAGEMENT DEVICE, INFORMATION MANAGEMENT METHOD, AND INFORMATION MANAGEMENT PROGRAM

(71) Applicant: NTT, INC., Tokyo (JP)

(72) Inventors: Masanori SHINOHARA, Musashino-shi, Tokyo (JP); Yoshiaki NAKAJIMA, Musashino-shi, Tokyo (JP); Ryota SATO, Musashino-shi, Tokyo (JP); Takuya MINAMI, Musashino-shi, Tokyo (JP); Yo KANEMOTO, Musashino-shi, Tokyo (JP); Hiroto NOMURA, Musashino-shi, Tokyo (JP); Yuki YAMANAKA, Musashino-shi, Tokyo (JP)

(73) Assignee: NTT, Inc., Tokyo (JP)

(21) Appl. No.: 19/157,702

(22) PCT Filed: Feb. 20, 2023
(86) PCT No.: PCT/JP2023/006085

§ 371 Date: Aug. 19, 2025

(51) Int. Cl. G06Q 30/018

(52) U.S. Cl. CPC G06Q 30/018

(57) ABSTRACT

An information management apparatus includes a memory and processing circuitry configured to acquire system information related to an information system and device information related to each device that constitutes the information system, generate a determination rule and determination rule points based on an importance of the determination rule, according to the system information and the device information acquired, calculate an evaluation score value of the device information acquired on a basis of the determination rule and the determination rule points generated, and select the device information in which the evaluation score value of the device information calculated is equal to or greater than a set threshold.

### TECHNICAL FIELD

The present invention relates to an information management apparatus, an information management method, and an information management program.

### BACKGROUND ART

In recent years, various IoT devices have been developed with development in the information technology field, and accordingly, laws and industry standards in the information technology field are also changing. Users are demanding that devices that they purchase conform to laws and industry standards, while manufacturers are seeking means to indicate that the devices that they develop conform to laws and industry standards.

### CITATION LIST

### Non Patent Literature

[NPL 1] “The Minimum Elements For a Software Bill of Materials (SBOM)” The United States Department of Commerce, [Retrieved on January 30, 2023], Internet <https://www.ntia.doc.gov/files/ntia/publications/sbom minimum elements report. pdf>

### SUMMARY OF INVENTION

### Technical Problem

However, the related art has the problem that it is sometimes impossible to quantitatively measure the quality and verification level of a device. For example, in the related art, there is a problem that device manufacturers have no means to quantitatively indicate the quality and verification level of their device to users. In addition, when users select a device to be procured, it is difficult to quantitatively determine whether or not the device conforms to laws and industry standards, and their own intended use and environment, and there is also a problem that the use of the device may be restricted after purchase.

### Solution to Problem

In order to solve the above-mentioned problems and achieve the object, according to the present invention, there is provided an information management apparatus including: an acquisition unit configured to acquire system information related to an information system and device information related to each device that constitutes the information system; a generation unit configured to generate a determination rule and determination rule points based on an importance of the determination rule, according to the system information and the device information acquired by the acquisition unit; a scoring unit configured to calculate an evaluation score value of the device information acquired by the acquisition unit on a basis of the determination rule and the determination rule points generated by the generation unit; and a selection unit configured to select the device information in which the evaluation score value of the device information calculated by the scoring unit is equal to or greater than a set threshold.

Here, system information refers to information other than device information to be described below that is obtained from outside, such as information on specifications and manuals of a device to be scored, software dependencies, whether or not a technical standards compliance certificate has been acquired, and determination rules set uniquely by the user, and information on the priority of such information. Furthermore, device information is not limited to a single device, and refers to information related to the entire information system, software, and other system components at various levels such as parts.

### Advantageous Effects of Invention

According to the present invention, an effect of quantitatively measuring the quality and verification level of a device is achieved.

### BRIEF DESCRIPTION OF DRAWINGS

FIG. 1 is a diagram illustrating an overview of a process of an information management apparatus according to an embodiment.

FIG. 2 is a block diagram illustrating an example of a configuration of the information management apparatus according to the embodiment.

FIG. 3 is a diagram illustrating a specific example of information management processing according to the embodiment.

FIG. 4 is a diagram illustrating a specific example of information management processing according to the embodiment.

FIG. 5 is a diagram illustrating a specific example of information management processing according to the embodiment.

FIG. 6 is a flowchart illustrating an example of information management processing according to the embodiment.

FIG. 7 is a diagram illustrating an example of a computer that executes an information management program.

### DESCRIPTION OF EMBODIMENTS

An embodiment of an information management apparatus, an information management method, and an information management program according to the present application will be described in detail below with reference to the drawings. Note that the information management apparatus, the information management method, and the information management program according to the present application are not limited to the embodiment.

### 1. Configuration Example of System

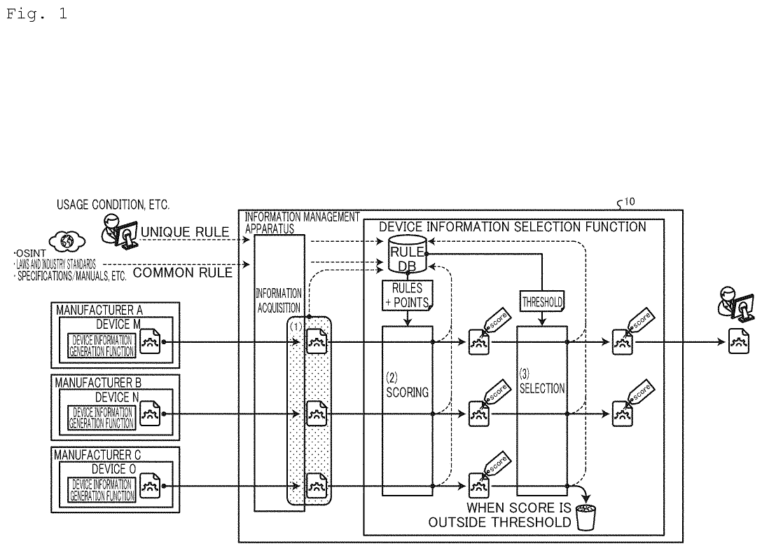

As illustrated in FIG. 1, an information management apparatus 10 according to an embodiment acquires system information such as laws and industry standards relating to a device, industry standards, open source intelligence (OSINT), and usage conditions set by a user and device information of the device to be scored, and after scoring each piece of device information, presents, to the user, devices with scores above a threshold. The user then selects an arbitrary device from among the presented devices that are guaranteed to match a certain level of intended use.

The information management apparatus 10 may be connected to a network via a wired or wireless connection and may acquire device information, etc. by transmitting and receiving information, or, even when not connected to a network, may acquire system information, device information, etc. by reading an external device such as a Universal Serial Bus (USB).

The information management apparatus 10 acquires system information related to the information system and device information related to each device that constitutes the information system, and generates a determination rule and determination rule points based on an importance of the determination rule according to the system information and the device information. Thereafter, the information management apparatus 10 calculates an evaluation score value of the device information on the basis of the determination rule and the determination rule point, and selects device information in which the evaluation score value of the device information is equal to or greater than a set threshold.

The information management apparatus 10 first acquires system information related to the information system and device information related to each device that constitutes the information system. For example, the information management apparatus 10 acquires device information such as the components and appearance of each device that constitutes the information system, and system information such as laws and industry standards, OSINT, and usage conditions set by the user related to the device from an external network, etc.

Then, the information management apparatus 10 generates a determination rule and determination rule points based on an importance of the determination rule, according to the system information and the device information. For example, the information management apparatus 10 generates a common rule, which is a determination rule corresponding to the acquired system information and device information, and a unique rule, which is a determination rule corresponding to the usage conditions of the user.

In addition, the information management apparatus 10, for example, sets a default value for the points that can be earned when the rule is satisfied for each information source of the generated determination rule, and increases or decreases the points earned from the default value according to the importance of the rule, thereby generating determination rule points for each item that constitutes the determination rule.

After that, the information management apparatus 10 calculates an evaluation score value of the device information on the basis of the determination rule and the determination rule points. For example, the information management apparatus 10 determines whether or not each item of the device information to be scored conforms to the determination rule on the basis of the generated determination rule and determination rule points, calculates the total points for each piece of device information unit by adding the points earned for the conformed determination rules, and then normalizes the total points to calculate the evaluation score value for each piece of device information.

Then, the information management apparatus 10 selects device information in which the evaluation score value of the device information is equal to or greater than the set threshold. For example, the information management apparatus 10 selects, from among the calculated evaluation score values of each piece of device information, device information corresponding to an evaluation score value that is equal to or greater than a recommended threshold generated by the information management apparatus 10 or a threshold set uniquely by the user, and presents the selected device information to the user.

### 2. Configuration of Information Management Apparatus 10

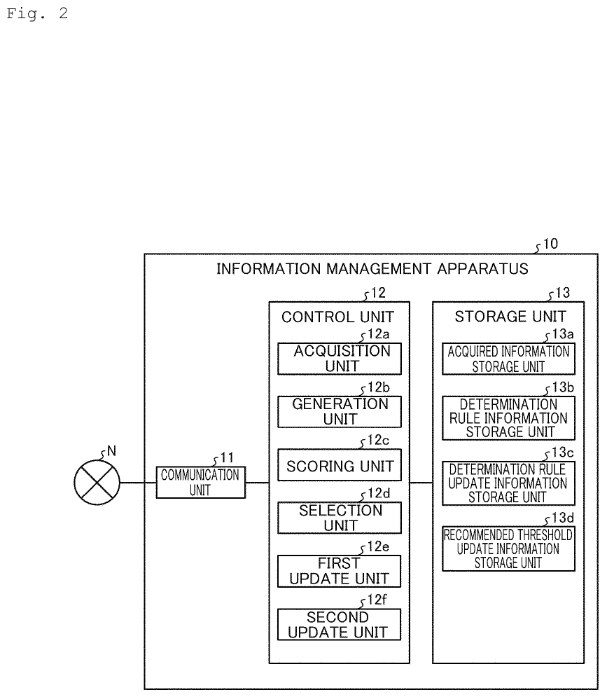

Next, the configuration of the information management apparatus 10 illustrated in FIG. 1 will be described with reference to FIG. 2. FIG. 2 is a block diagram illustrating an example of a configuration of the information management apparatus according to the embodiment. As illustrated in FIG. 2, the information management apparatus 10 according to the embodiment includes a communication unit 11, a control unit 12, and a storage unit 13. Here, in the example illustrated in FIG. 2, the communication unit 11 is connected to an external network N, but the present invention is not limited thereto.

For example, when the information management apparatus 10 is not connected to the network N, information may be acquired from outside by reading information using a portable medium such as a USB memory.

The communication unit 11 is implemented, for example, by a network interface card (NIC) or the like, and is connected to the network N via a wired or wireless connection to transmit and receive information. As mentioned above, the communication unit 11 does not need to be connected to the network N, and an acquisition unit 12a to be described below acquires information from the network N or a portable medium such as a USB memory via the communication unit 11.

The storage unit 13 is implemented, for example, by a storage device such as a random access memory (RAM) or a hard disk.

The storage unit 13 stores data and programs necessary for various processes performed by the control unit 12. The storage unit 13 includes an acquired information storage unit 13a, a determination rule information storage unit 13b, a determination rule update information storage unit 13c, and a recommended threshold update information storage unit 13d, which are closely related to the present invention.

The acquired information storage unit 13a stores, for example, device information such as the appearance and source code of each device that constitutes the information system acquired by the acquisition unit 12a to be described below, and system information such as laws and industry standards, OSINT, and unique usage conditions set by the user related to the device.

The determination rule information storage unit 13b stores, for example, determination rules and determination rule points generated by a generation unit 12b to be described below from device information and system information.

The determination rule update information storage unit 13c stores, for example, information on the frequency of conformance for each item of the determination rule, which has been updated by a first update unit 12e to be described below, and the value of earned points updated on the basis of that information.

The recommended threshold update information storage unit 13d stores, for example, information such as the usage rate of the recommended threshold generated by the information management apparatus 10, which has been updated by a second update unit 12f to be described below, and unique threshold values set by the user for each use case.

The control unit 12 is implemented by a central processing unit (CPU) or a micro processing unit (MPU), etc. executing various programs stored in storage devices inside each device using a RAM as a work area, and is implemented by integrated circuits such as an application specific integrated circuit (ASIC) or a field programmable gate array (FPGA). In addition, the control unit 12 includes an acquisition unit 12a, a generation unit 12b, a scoring unit 12c, and a selection unit 12d, and may also include a first update unit 12e and a second update unit 12f as necessary.

The acquisition unit 12a acquires system information related to the information system and device information related to each device that constitutes the information system. For example, the acquisition unit 12a acquires device information such as an appearance image, source code, binary, program output, and communication log of the device to be scored, and system information to be described below, and stores them in the acquired information storage unit 13a.

The acquisition unit 12a also acquires, as system information, information on specifications and manuals for devices, laws and industry standards related to devices, OSINT, and user usage conditions. For example, the acquisition unit 12a acquires, as system information, information other than the above-mentioned device information that is obtained from outside, such as information on specifications and manuals of the device to be scored, software dependencies, whether or not a technical standards compliance certificate has been acquired, and determination rules set uniquely by the user, and information on the priority of such information.

Note that the components of the above-mentioned system information, such as information on specifications and manuals for devices, laws and industry standards related to devices, OSINT, and user usage conditions, are not essential information for system information.

Here, for example, the acquisition unit 12a may acquire information regarding software dependencies of the above-described device to be scored from OSINT, may acquire information regarding whether or not a technical standards compliance certificate has been acquired from the Ministry of Internal Affairs and Communications website, etc., and may acquire information regarding information set by the user through manual input by the user.

The generation unit 12b generates a determination rule and determination rule points based on an importance of the determination rule, according to the system information and the device information acquired by the acquisition unit 12a.

The generation unit 12b then stores the generated determination rule and the determination rule points in the determination rule information storage unit 13b. For example, the generation unit 12b uses the system information and device information acquired by the above-described acquisition unit 12a to generate a determination rule composed of a common rule generated corresponding to the device to be scored and a unique rule generated based on information on the usage conditions set uniquely by the user, and stores the determination rule in the determination rule information storage unit 13b.

Here, the generation unit 12b generates, for example, items such as the library used, communication frequency, communication port, and communication volume for the device to be scored as the determination rule to be generated.

Furthermore, for example, after generating the above-mentioned common rules, the generation unit 12b may acquire information on the user's unique usage conditions from the user and generate unique rules on the basis of the information.

Furthermore, for example, the above-mentioned common rules may be partially changed or their application may be limited based on user input, or mandatory rules that should be satisfied in scoring may be set. Furthermore, for example, the above-mentioned determination rules may be expressed by mathematical formulas, or a model generated by machine learning may be used as the determination rules.

Furthermore, the generation unit 12b generates determination rule points based on an importance of each item of the determination rule by, for example, setting high earned points for items generated from highly reliable information sources such as laws and industry standards for each item of the determination rule, and setting low earned points for items generated using other external information as an information source, and stores the determination rule points in the determination rule information storage unit 13b.

In addition, for example, when generating determination rule points for the above-mentioned common rule, the generation unit 12b may refer to information on the frequency of conformance for each determination rule item stored in the determination rule update information storage unit 13c and information on the value of earned points updated on the basis of that information, and may determine that items of determination rules with a high frequency of conformance are of a high importance and generate determination rule points with high values.

Furthermore, the generation unit 12b may further generate a recommended threshold according to the device information. For example, the generation unit 12b generates a recommended threshold, which is a value recommended as a threshold to be used by the selection unit 12d to be described below, in response to device information such as the type of device. In addition to the device information, the generation unit 12b may generate a recommended threshold in response to a user's use case, such as a manufacturer's shipping determination or a user's device selection.

Furthermore, the generation unit 12b may generate a recommended threshold by referring to information such as the usage rate of the recommended threshold generated by the information management apparatus 10 stored in the recommended threshold update information storage unit 13d, or the unique threshold value set by the user for each use case.

The scoring unit 12c calculates an evaluation score value of the device information acquired by the acquisition unit 12a on the basis of the determination rule and the determination rule points generated by the generation unit 12b. For example, the scoring unit 12c refers to the determination rules stored in the determination rule information storage unit 13b and the determination rule points set for each item of the determination rule, and determines whether or not each item of the device information to be scored satisfies the corresponding item of the determination rule, and if it is satisfied, calculates the determination rule points for that item as the point for that item.

Then, the scoring unit 12c calculates, for example, a normalized value obtained by adding up the points calculated for each item as the evaluation score value of the device information. In addition, the scoring unit 12c normalizes the total earned points and calculates the evaluation score value for each piece of device information, thereby making it possible to compare evaluation score values between devices with equivalent functions even in a case where the determination rules are different.

The selection unit 12d selects the device information in which the evaluation score value of the device information calculated by the scoring unit 12c is equal to or greater than a set threshold. For example, the selection unit 12d compares the evaluation score value calculated for each piece of device information with a set threshold, selects device information whose evaluation score value is equal to or greater than the threshold, and presents the selected device information to the user.

The set threshold may be preset to use the recommended threshold generated by the above-described generation unit 12b, or after the recommended threshold is generated, a unique threshold input by the user may be set, or information on the unique threshold may be collected and a value calculated by statistical processing may be automatically set.

The first update unit 12e updates information related to the determination rule point on the basis of a scoring result of the device information from the scoring unit 12c. For example, the first update unit 12e acquires information on conformance of each item of the common rule from the scoring result of the device information, and feeds back a predetermined numerical value for the conformed items.

Then, for example, in a case where the total value of the values fed back for any item becomes equal to or greater than a certain value, the first update unit 12e updates the determination rule points for that item to a higher value. The first update unit 12e stores information on conformance of each item of the acquired common rule and information on the updated determination rule points in the determination rule update information storage unit 13c.

The second update unit 12f updates information related to the recommended threshold on the basis of the set threshold. For example, the second update unit 12f acquires information on the threshold used in the above-mentioned process of the selection unit 12d, and feeds back the threshold for each piece of device information or each use case of a user.

Then, for example, the second update unit 12f calculates values such as the average value or median value of the fed-back thresholds for each piece of device information to be scored or for each use case such as a manufacturer's shipping determination or a user's device selection, and updates the calculated values as recommended thresholds for each use case. The second update unit 12f stores the acquired threshold information and the updated recommended threshold information in the recommended threshold update information storage unit 13d.

In addition, the second update unit 12f may, for example, in the above-mentioned calculation process of values such as the average value and median value, target all thresholds used in the above-mentioned selection process, or may target only the thresholds of the selected device information. Furthermore, the second update unit 12f may calculate a weighted average during the above-mentioned calculation process of the average value, for example.

### 3. Specific Example of Information Management Processing

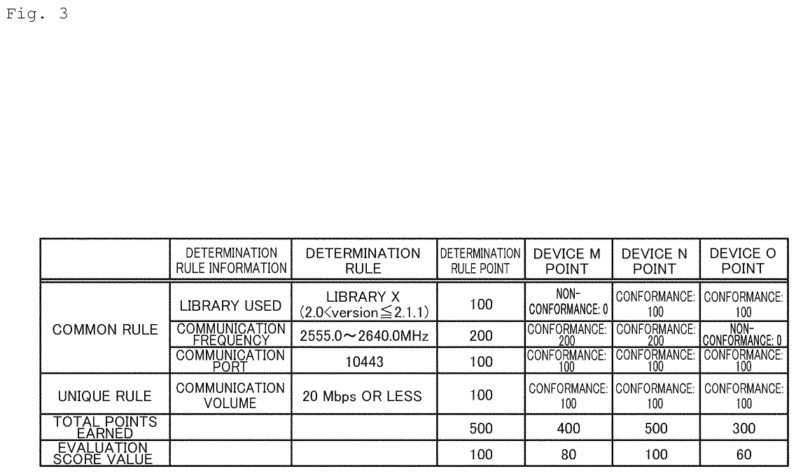

Here, the scoring process of the device information by the information management apparatus 10 according to the present embodiment will be described with reference to FIG. 3. FIG. 3 is a diagram illustrating a specific example of information management processing according to the embodiment. The example in FIG. 3 shows a specific example of the scoring process in a situation where a user selects a device that meets the usage conditions from “device M, device N, device O”. In the example illustrated in FIG. 3, three determination rules for “library used, communication frequency, and communication port” are generated as common rules, and a determination rule for “communication volume” is generated as a unique rule.

Furthermore, the item regarding “communication frequency” generated from a highly reliable information source is assigned a determination rule point of “200”, while the other items are assigned a determination rule point of “100”. The information management apparatus 10 determines whether or not the device information to be scored satisfies each item of the four determination rules, which are a combination of the common rule and the unique rule described above.

As a result of the scoring, since “device M” does not conform to the determination rule “library X (2.0<version<2.1.1)” for the “library used”, points are not added for that item, the total points become “400”, and the normalized evaluation score value is calculated as “80”. In contrast, since “device N” conforms to all four items of the determination rules, the evaluation score value is calculated as “100”.

On the other hand, since “device 0” does not conform to the determination rule “2555.0 to 2640.0 MHz” for the “communication frequency”, points are not added for that item, the total points earned become “300”, and the normalized evaluation score value is calculated as “60”.

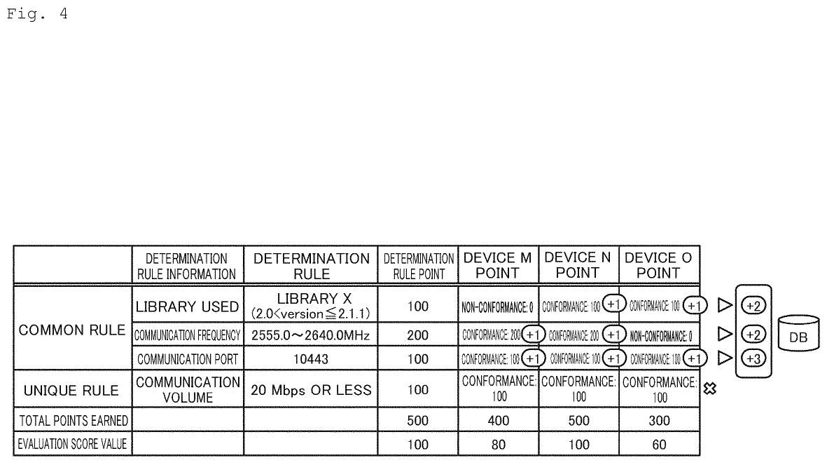

Next, a process for updating information related to determination rule points of the common rule in the example illustrated in FIG. 3 will be described with reference to FIG. 4. FIG. 4 is a diagram illustrating a specific example of information management processing according to the embodiment. In the example illustrated in FIG. 4, one point is fed back for each conformance in each item of the determination rule.

That is, for the item “communication port”, since “device M”, “device N”, and “device 0” are each in conformance, it is determined that there are three conformances, and a total of “three points” is fed back. On the other hand, for the items “library used” and “communication frequency”, the number of conformances of both of these items is two and thus a total of “two points” is fed back. In addition, since the item “communication volume” is a unique rule set by the user, no feedback is provided. Moreover, the process in FIG. 4 is merely an example, and it is not necessary to feed back one point per application.

Accordingly, the information management apparatus 10 can determine that an item having a large number of conformances is more appropriate as industry standards and increase the numerical value that is fed back, thereby continuously improving the validity of the scoring.

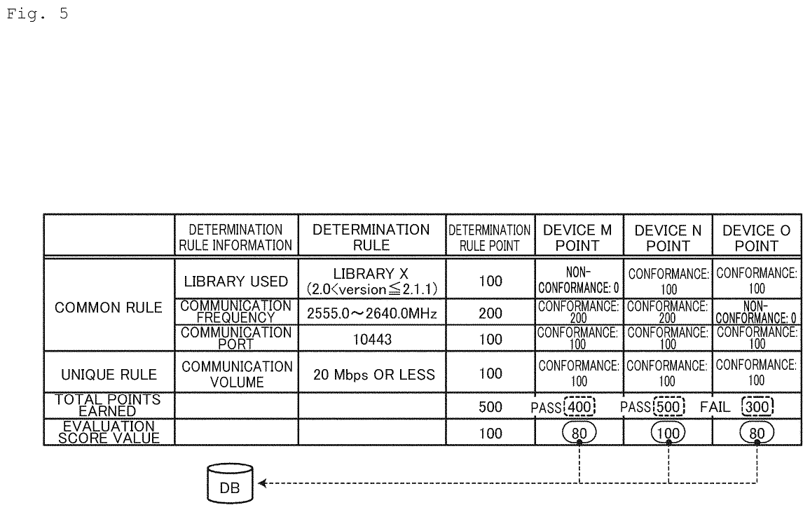

Next, the process of selecting device information and the process of updating information related to recommended thresholds in the example illustrated in FIG. 3 will be described with reference to FIG. 5. FIG. 5 is a diagram illustrating a specific example of information management processing according to the embodiment. In the example illustrated in FIG. 5, a threshold of “80” is set for each of “device M”, “device N”, and “device 0”.

As in the example illustrated in FIG. 3 described above, the evaluation score value of “device M” is “80”, the evaluation score value of “device N” is “100”, and the evaluation score value of “device 0” is “60”. Therefore, the information management apparatus 10 selects “device M” and “device N”, which have evaluation score values equal to or greater than the set threshold “80”, as passed device information and presents them to the user.

Furthermore, in the above-mentioned selection process, the information management apparatus 10 uses the threshold of “80” for each of “device M”, “device N”, and “device 0”, and therefore the threshold of “80” is fed back three times. The threshold that is fed back is stored together with the device information of each device that is the target of scoring and the information on the user's device selection, which is the current use case.

### 4. Example of Information Management Processing

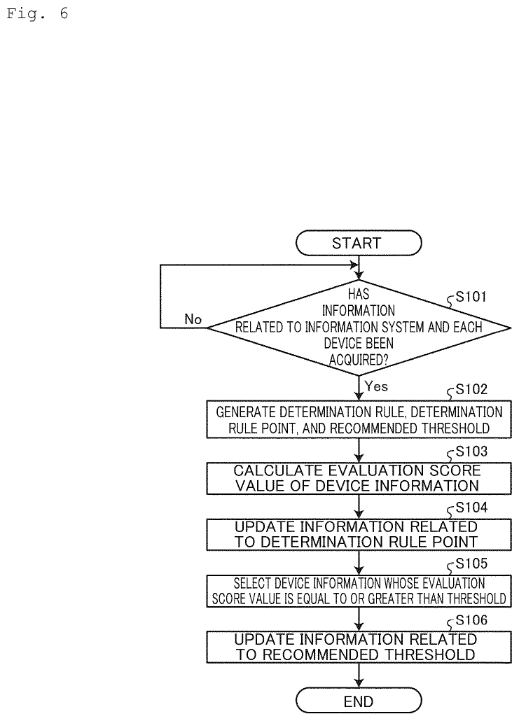

Next, information management processing of the information management apparatus 10 will be described with reference to FIG. 6. FIG. 6 is a flowchart illustrating an example of information management processing according to the embodiment. First, the acquisition unit 12a acquires information related to the information system and device information of each device (step S101).

If the information related to the information system and the device information of each device has been acquired (step S101; Yes), the generation unit 12b generates a determination rule, a determination rule point, and a recommended threshold (step S102).

On the other hand, if information related to the information system and the device information of each device has not been acquired (step S101; No), the acquisition unit 12a waits until information related to the information system and the device information of each device is acquired.

Then, the scoring unit 12c calculates the evaluation score value of the device information (step S103). After that, the first update unit 12e updates the information related to the determination rule point (step S104). Then, the selection unit 12d selects device information whose evaluation score value is equal to or greater than the set threshold (step S105).

Thereafter, the second update unit 12f updates the information related to the recommended threshold (step S106), and the information management apparatus 10 ends the process.

### 5. Effects of Embodiment

As described above, the information management apparatus 10 according to the present embodiment includes an acquisition unit 12a, a generation unit 12b, a scoring unit 12c, and a selection unit 12d. The acquisition unit 12a acquires system information related to the information system and device information related to each device that constitutes the information system. The generation unit 12b generates a determination rule and determination rule points based on an importance of the determination rule, according to the system information and the device information acquired by the acquisition unit 12a.

The scoring unit 12c calculates an evaluation score value of the device information acquired by the acquisition unit 12a on the basis of the determination rule and the determination rule points generated by the generation unit 12b. The selection unit 12d selects the device information in which the evaluation score value of the device information calculated by the scoring unit 12c is equal to or greater than a set threshold.

Accordingly, the information management apparatus 10 can use determination rules generated from laws and industry standards, specifications, OSINT, the user's unique rules, etc. to evaluate the acquired device information based on whether or not the device information conforms to the determination rules, thereby achieving the effect of quantitatively measuring the quality and verification level of the device.

Moreover, the generation unit 12b of the information management apparatus 10 further generates a recommended threshold according to the device information, and a first update unit 12e and a second update unit 12f are further provided. The first update unit 12e updates information related to the determination rule point on the basis of the scoring result of the device information from the scoring unit 12c. The second update unit 12f updates information related to the recommended threshold on the basis of the set threshold.

Accordingly, the information management apparatus 10 can present the user with recommended thresholds that correspond to the device information, and can update the presented recommended thresholds on the basis of information on thresholds that have been used in the past, thereby achieving the effect of continuously improving the validity of the presented recommended thresholds. Furthermore, the information management apparatus 10 also updates the determination rule points depending on whether each item of the determination rule is in conformity with the determination rule, thereby achieving the effect of continuously improving the validity of the scoring.

Furthermore, the acquisition unit 12a of the information management apparatus 10 acquires, as system information, information on specifications and manuals for devices, laws and industry standards related to devices, OSINT, and user usage conditions. Accordingly, the information management apparatus 10 can generate common rules from system information composed of specifications, manuals, laws, industry standards, and OSINT corresponding to the acquired device information, and from the above-mentioned device information, and can generate unique rules from the user's unique usage conditions to evaluate the device information to be scored, thereby achieving the effect of appropriately evaluating the device information using determination rules based on appropriate information sources or determination rules tailored to the user's needs.

### 6. System Configuration, Etc.

Among the processes described in the embodiment, some of the processes described as being automatically performed can be performed manually.

Alternatively, all or some of the processes described as being manually performed can be performed automatically by a known method. In addition, information including the processing procedure, specific names, various types of data and parameters that are illustrated in the above document and drawings may be arbitrarily changed unless otherwise described. For example, the various types of information illustrated in each drawing is not limited to the information illustrated in the drawings.

In addition, each component of each device that has been illustrated is functionally conceptual, and is not necessarily physically configured as illustrated. In other words, the specific aspects of distribution and integration of the devices are not limited to those illustrated in the drawings, all or part of the components may be distributed or integrated functionally or physically in desired units depending on various kinds of loads and states of use. Furthermore, all or any part of each processing function performed in each device can be implemented by a CPU and a program analyzed and executed by the CPU, or can be implemented as hardware by a wired logic.

For example, a part or all of the storage unit 13 illustrated in FIG. 2 may not be held by the information management apparatus 10 but may be held in a storage server or the like. In this case, the information management apparatus 10 accesses the storage server to acquire various types of information.

### 7. Hardware Configuration

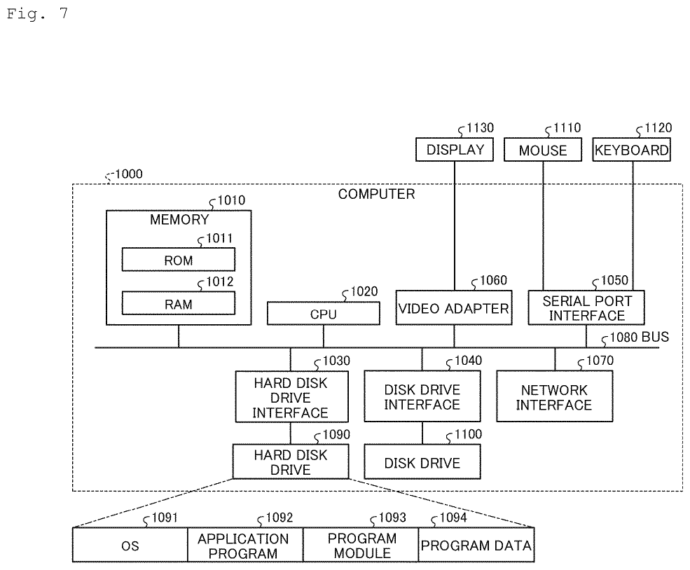

FIG. 7 is a diagram illustrating an example of a hardware configuration. The information management apparatus 10 according to the embodiment described above is implemented by a computer 1000 having a configuration as illustrated in FIG. 7, for example.

FIG. 7 is a diagram illustrating an example of a computer that executes an information management program. The computer 1000 includes, for example, a memory 1010 and a CPU 1020. Further, the computer 1000 also includes a hard disk drive interface 1030, a disk drive interface 1040, a serial port interface 1050, a video adapter 1060, and a network interface 1070.

These units are connected by a bus 1080.

The memory 1010 includes a read only memory (ROM) 1011 and a RAM 1012. The ROM 1011 stores, for example, a boot program such as a basic input output system (BIOS). The hard disk drive interface 1030 is connected to a hard disk drive 1090.

The disk drive interface 1040 is connected to a disk drive 1100. For example, a removable storage medium such as a magnetic disk or an optical disc is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an operating system (OS) 1091, an application program 1092, a program module 1093, and program data 1094. That is, a program that defines each process of the information management apparatus 10 is implemented as the program module 1093 in which codes executable by the computer 1000 are described. The program module 1093 is stored in, for example, the hard disk drive 1090. For example, the program module 1093 for executing processing similar to the functional configuration in the information management apparatus 10 is stored in the hard disk drive 1090. Note that the hard disk drive 1090 may be replaced with a solid state drive (SSD).

Furthermore, the setting data used in the processes of the above-described embodiment is stored, for example, in the memory 1010 or the hard disk drive 1090 as the program data 1094. Then, the CPU 1020 reads the program module 1093 and the program data 1094 stored in the memory 1010 or the hard disk drive 1090 into the RAM 1012 and executes them as necessary.

Note that the program module 1093 and the program data 1094 are not limited to being stored in the hard disk drive 1090, and may be stored in, for example, a detachable storage medium and read by the CPU 1020 via the disk drive 1100 or the like. Alternatively, the program module 1093 and the program data 1094 may be stored in another computer connected via a network (LAN, WAN, etc.). Then, the program module 1093 and the program data 1094 may be read by the CPU 1020 from another computer via the network interface 1070.

### REFERENCE SIGNS LIST

10 Information management apparatus
11 Communication unit
12 Control unit
12a Acquisition unit
12b Generation unit
12c Scoring unit
12d Selection unit
12e First update unit
12f Second update unit
13a Acquired information storage unit
13b Determination rule information storage unit
13c Determination rule update information storage unit
13d Recommended threshold update information storage unit

1. An information management apparatus comprising:
a memory; and
processing circuitry configured to:
acquire system information related to an information system and device information related to each device that constitutes the information system;
generate a determination rule and determination rule points based on an importance of the determination rule, according to the system information and the device information acquired;
calculate an evaluation score value of the device information acquired by the acquisition unit on a basis of the determination rule and the determination rule points generated; and
select the device information in which the evaluation score value of the device information calculated is equal to or greater than a set threshold.

2. The information management apparatus according to claim 1, wherein the processing circuitry is further configured to:
generate a recommended threshold according to the device information;
update information related to the determination rule points on the basis of a scoring result of the device information; and
update information related to the recommended threshold on the basis of the set threshold.

3. The information management apparatus according to claim 1, wherein the processing circuitry is further configured to acquire, as system information, information on specifications and manuals for devices, laws and industry standards related to devices, open source intelligence (OSINT), and user usage conditions.

4. An information management method executed by an information management apparatus, the information management method comprising:
acquiring system information related to an information system and device information related to each device that constitutes the information system;
generating a determination rule and determination rule points based on an importance of the determination rule, according to the system information and the device information acquired;
calculating an evaluation score value of the device information acquired on a basis of the determination rule and the determination rule points generated; and
selecting the device information in which the evaluation score value of the device information calculated is equal to or greater than a set threshold.

5. A non-transitory computer-readable recording medium storing therein an information management program that causes a computer to execute a process comprising:
acquiring system information related to an information system and device information related to each device that constitutes the information system;
generating a determination rule and determination rule points based on an importance of the determination rule, according to the system information and the device information acquired;
calculating an evaluation score value of the device information acquired on a basis of the determination rule and the determination rule points generated; and
selecting the device information in which the evaluation score value of the device information calculated is equal to or greater than a set threshold.
